(19) United States
(12) Patent Application Publication
(10) Pub. No.: US 2011/0259307 A1
(43) Pub. Date: Oct. 27, 2011

(54) IGNITION COIL

(75) Inventor: Siegmund Oberer, Berglen-Kottweil (DE)

(73) Assignee: BorgWarner BERU Systems GmbH, Ludwigsburg (DE)

(21) Appl. No.: 13/089,856

(22) Filed: Apr. 19, 2011

(30) Foreign Application Priority Data
Apr. 21, 2010 (DE) 10 2010 017 902.7

(51) Int. Cl. H01F 38/12

(52) U.S. Cl. 123/634

(57) ABSTRACT

The invention relates to an ignition coil for an internal combustion engine, comprising a housing (1) which holds a connector (2) and is potted with an electrically insulating compound. According to the invention, it is provided that the connector (2) holds a printed circuit board (4), the connector (2) comprises contact pins (5, 5a) for contacting a female connector matching the connector (2), said contact pins (5, 5a) being pressed into the printed circuit board (4), contact forks (6) which each clamp a conductor (7) in the interior region of the housing (1) are inserted into the printed circuit board (4).

The invention relates to an ignition coil for an internal combustion engine. Ignition coils of this kind are used in motor vehicles in order to generate a high voltage from a vehicle electrical system voltage of, for example, 12 volts, said high voltage being required by an ignition plug.

To enable the connection of ignition coils with minimal effort, the housing of said ignition coils, usually, holds a connector. To mount such a built-in connector to an ignition coil housing, contact pins of the connector can be connected to conductors in the interior region of the ignition coil housing by soldering or welding. In order to avoid the effort of welded or soldered connections, it is also known to connect contact pins of the connector, i.e., connector pins, to contacts in the interior region of the ignition coil housing by screwing or riveting.

It is the object of the present invention to show a way how an ignition coil can be produced with reduced effort.

This object is solved by an ignition coil having the features presented in claim 1. Advantageous further developments of the invention are the subject matter of subordinate claims.

In an ignition coil according to the invention, the connector holds a printed circuit board. Contact pins of the connector, which are sometimes also referred to as connector pins, are pressed into the printed circuit board on one side. Contact forks which each clamp a conductor in the interior region of the housing project from the other side of the printed circuit board. In other words, electrical contacting of the connector pins with conductors in the interior region of the ignition coil housing is achieved by means of a printed circuit board and contact forks which are connected to a conductor in the interior region of the ignition coil housing in a clamping manner.

The built-in connector of an ignition coil according to the invention can be pre-assembled with low effort. When the connector is installed into the housing, the contact forks allow establishing a clamped connection which can be implemented with an effort that is essentially reduced as compared with a soldered or a welded connection. Subsequently, mechanical securing of the clamped connection is achieved by potting the housing with an electrically insulating compound. The contact forks and the conductors clamped by them as well as the printed circuit board are, therefore, embedded in a potting compound, with the result that the contact cannot be broken even in the event of vibrations such as they can, for example, occur during operation of a motor vehicle.

An advantageous further development of the invention provides that the connector is connected to a housing wall by means of a tongue and groove connection. In this manner, the connector can be attached to the housing with low effort. Preferably, the housing comprises two opposite grooves, with a tongue or strip provided on the connector being slid into each of these grooves. As a matter of principle, however, it is also possible to provide one groove or even both grooves on the connector, with the housing wall projecting into these grooves.

Another advantageous further development of the invention provides that the contact forks comprise a bent section, for example, a section that is bent by 90°, between a section inserted into the printed circuit board and a free end. In this manner, a clamped connection can be established in a particularly easy manner, for the connector is shifted in the plane of the printed circuit board. This can be achieved particularly advantageously by the movement required for inserting the connector into the housing, for example, by sliding the tongue into the groove of the connection wherein, at the same time, the clamped connection is also produced between the conducting interior region of the ignition coil housing and the contact forks. The contact forks will, then, extend in the direction of the plane of the printed circuit board and, therefore, also in the direction of the inserting or sliding movement required for establishing the tongue and groove connection.

Another advantageous further development of the invention provides that the contact forks project into a slotted-type pocket. When a contact fork is slid onto a conductor in the interior region of the ignition coil housing, metal chips or similar metal particles might be scraped off from the contact forks or the conductors. Since the contact fork immerses in a slotted-type pocket, metal particles which might detach from the contact forks or the conductors clamped by them while the clamped connection is being established are collected in the pocket and can, therefore, not cause any damage in the interior region of the ignition coil, for example, by shunts. In a housing part that is produced from plastic by injection-molding, suitable pockets can be provided without any major effort. Suitable pockets can, for example, be provided between an outside wall of the housing part and an inside wall delimiting the pocket.

Another advantageous further development of the invention provides that the contact pins are each inserted into the printed circuit board with an end section which comprises a pair of contact branches with a clearance therebetween. The contact branches can, for example, form a fork the prongs of which are pressed together when they are pressed in. Preferably, however, the contact branches are connected to each other at their two ends. It is to particular advantage if the contact branches of a pair of contact branches are curved outwards. The clearance between the branches of a pair of contact branches can, for example, have the shape of a slot, more preferably, the shape of a biconvex lens.

Further details and advantages of the invention are illustrated by means of exemplary embodiments and with reference being made to the enclosed drawings. Therein, equal parts and parts that correspond to each other are labeled with corresponding reference numbers. In the Figures,

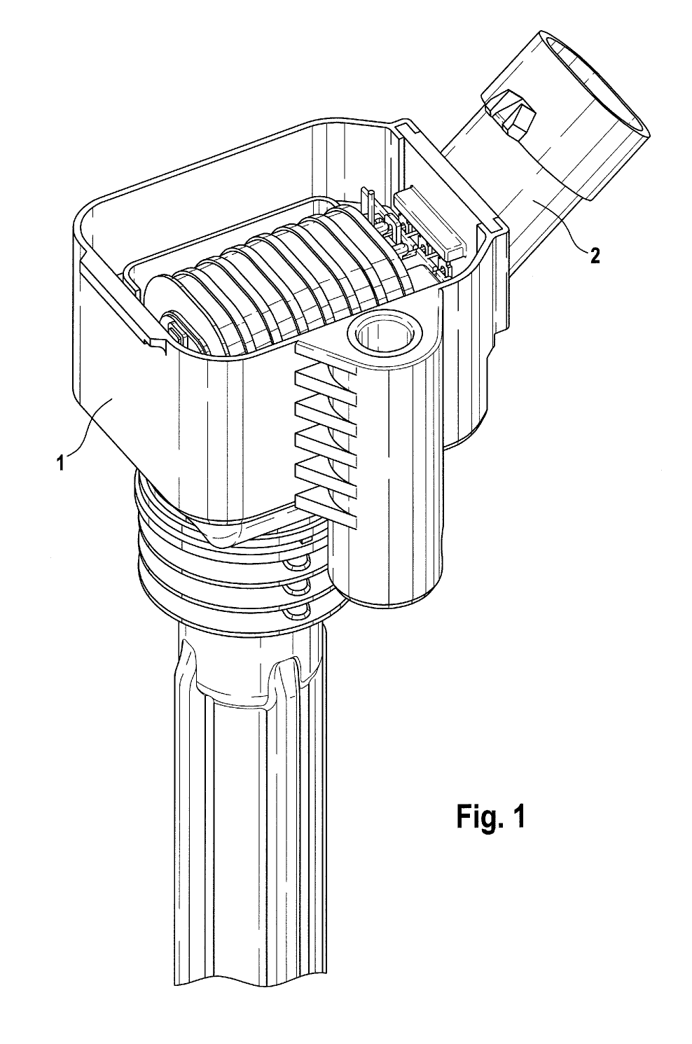

FIG. 1 shows an exemplary embodiment of an ignition coil, with the housing cover being removed and without potting compound;

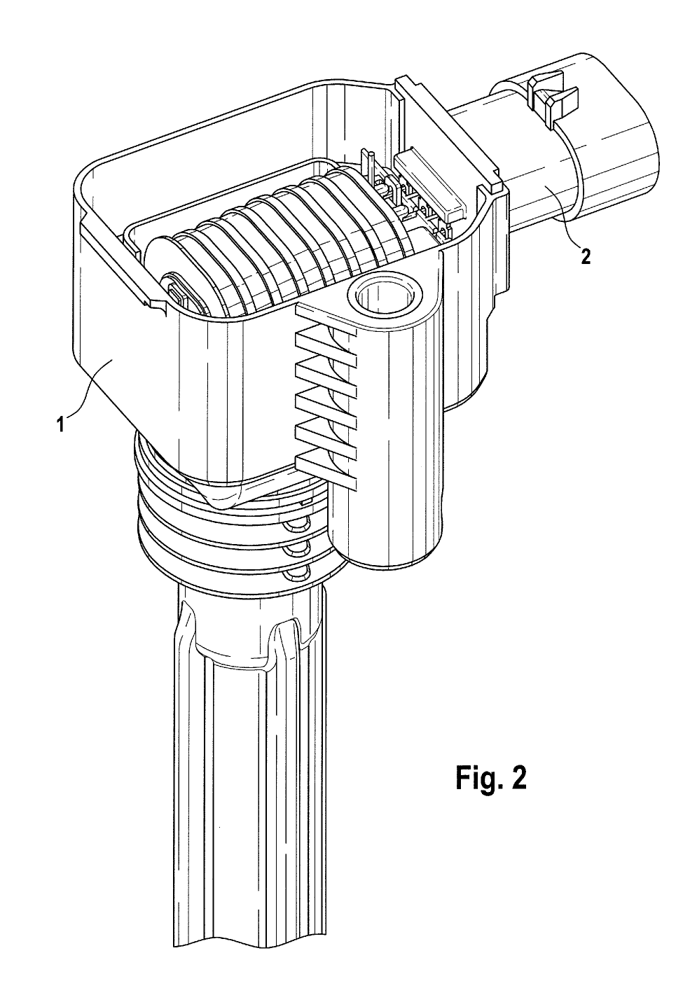

FIG. 2 shows a further exemplary embodiment of an ignition coil, with the housing cover being removed and without potting compound;

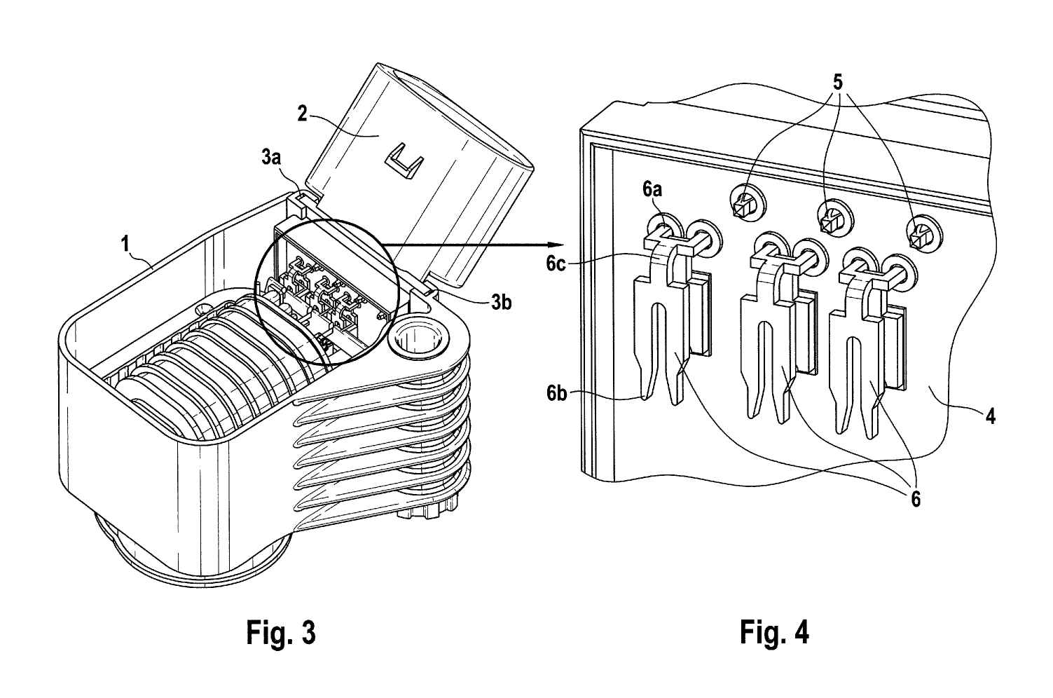

FIG. 3 is a detail view referring to FIG. 1;

FIG. 4 shows a detail of the rear of the connector of the exemplary embodiment shown in FIG. 3, with the contact pins being pressed into the printed circuit board;

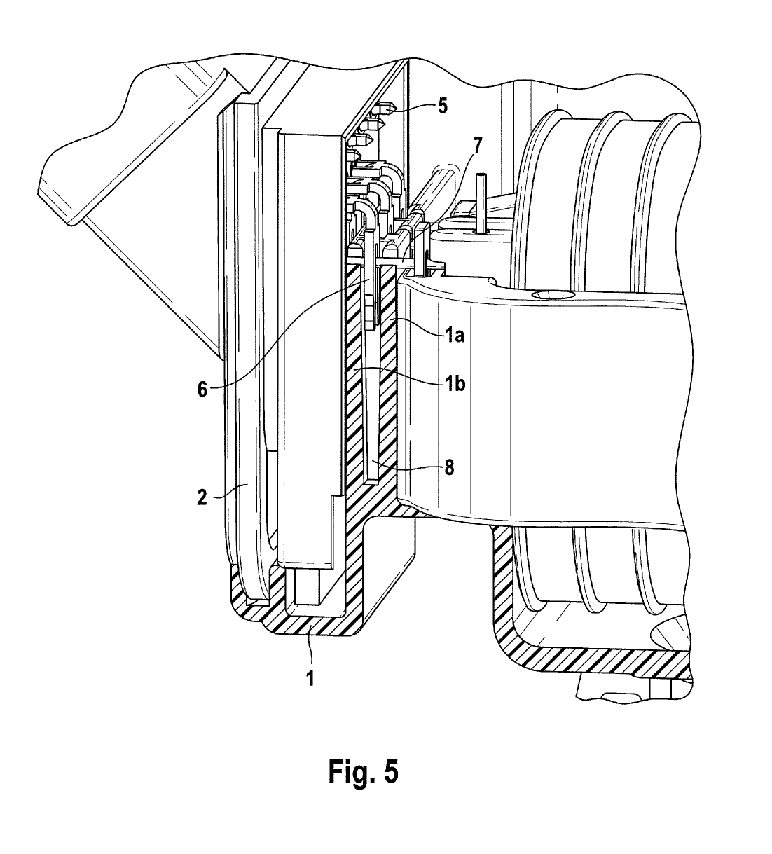

FIG. 5 is a sectional view referring to FIG. 3, wherein the contact forks are positioned in slotted-type pockets;

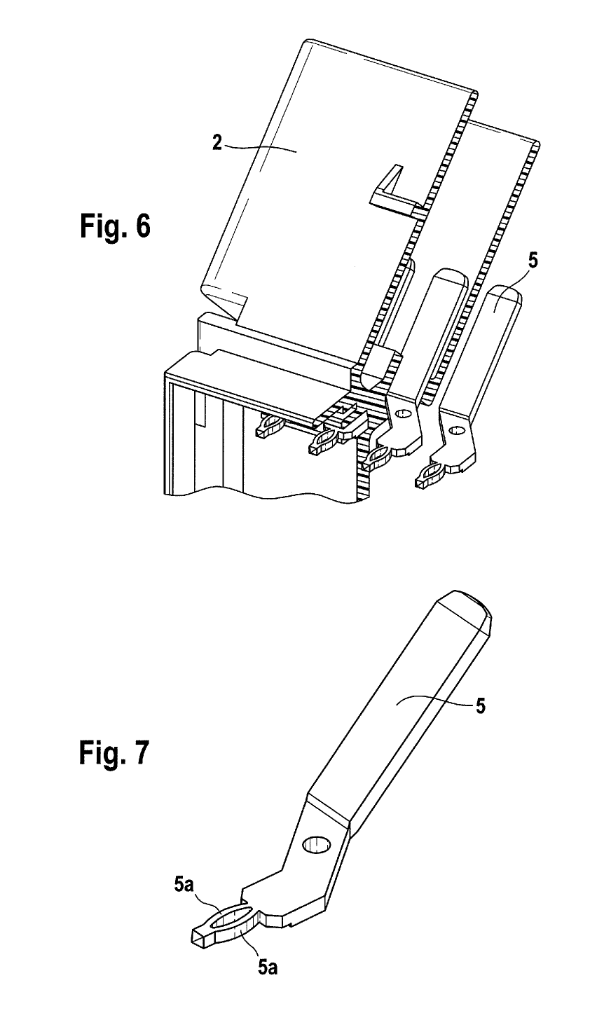

FIG. 6 is a sectional view of the connector of the exemplary embodiment shown in FIG. 3, without printed circuit board; and

FIG. 7 shows a contact pin of the connector of the exemplary embodiment shown in FIG. 3.

FIGS. 1 and 2 show two exemplary embodiments of an ignition coil without housing cover. The ignition coils each have a housing 1 which holds a built-in connector 2 and differ in nothing but the orientation of the connector 2. In the exemplary embodiment of FIG. 1, the connector 2 is directed upwards at a slanted angle and, in the exemplary embodiment of FIG. 2, it is directed sidewards.

A primary winding and a secondary winding as well as a control circuit can be arranged in the housing 1 in the usual manner. In respect thereof, the ignition coils shown do not differ from commercially available ignition coils, so that more detailed illustrations are not required in this regard.

FIG. 3 is a detail view referring to FIG. 1. The connector 2 is mounted to the housing 1 by means of a tongue and groove connection. To achieve this, the housing 1 comprises two opposite grooves 3a, 3b, with a tongue which is provided on the connector and can be formed by a base plate or a frame of the connector housing being slid into said grooves 3a, 3b.

FIG. 4 shows a detail of the rear of the connector 2, said rear facing the interior region of the housing. The connector 2 holds a printed circuit board 4. Contact pins 5 which are, in particular, shown in FIGS. 6 and 7 and serve to contact a female connector matching the male connector 2 are pressed into this printed circuit board 4. The ends of the contact pins 5, which are projecting from the rear of the printed circuit board 4, can be recognized in FIG. 4. Furthermore, contact forks 6 which each clamp a conductor 7 in the interior region of the housing 1 are inserted into the printed circuit board 4. This can, in particular, be recognized in the sectional view shown in FIG. 5.

Preferably, the contact forks 6 are pressed, but can also be soldered, into the printed circuit board 4. FIG. 4 shows that the contact forks 6 comprise a bent section 6c between a section 6a that is inserted into the printed circuit board 4 and a free end 6b. In the exemplary embodiment shown, the bent section 6c is bent at a right angle. A gap that is getting broader in the form of a funnel towards the end is provided between the prongs of the contact forks 6, in order to facilitate clamping onto a conductor 7.

As is shown in FIG. 5, bar-type or wire-type conductors 7 extend in the interior region of the ignition coil housing 1, said conductors 7 projecting into the gap between the prongs of the contact forks 6. In the exemplary embodiment shown, the clamped conductors 7 extend perpendicular to the printed circuit board 4. The clamped conductors 7 rest on a housing part 1a, 1b in front of and behind the contact forks 6. These two housing parts 1a, 1b form a slotted-type pocket 8, with the contact forks 6 projecting into said slotted-type pocket 8.

When the contact forks 6 are slid onto the conductors 7 to be clamped, chips or metal particles might be stripped off. To ensure that these metal particles do not cause any short-circuits or other damage in the interior region of the ignition coil housing 1, said metal particles are collected by the slotted-type pocket 8.

After the connector 2 has been mounted to the housing 1 and the conductors 7 extending in the ignition coil housing have been contacted by clamping the contact forks 6, the interior region of the housing is potted with an electrically insulating compound. For example, casting resin is appropriate. After the interior region of the housing has been filled with compound, the housing 1 is closed with a cover that is not shown here.

As has already been mentioned, the contact pins 5 of the connector 2, which are pressed into the printed circuit board 4, are shown in FIGS. 6 and 7. The contact pins 5 are each inserted into the printed circuit board 4 with an end section which comprises a pair of contact branches 5a with an elongated clearance therebetween. The contact branches 5a of a pair of contact branches are connected at their ends. In the exemplary embodiment shown, the clearance has the shape of a biconvex lens. The contact branches 5a of a pair of contact branches, which are curved outwards, are pressed together when they are pressed into breakthroughs of the printed circuit board 4, with the clearance being narrowed therein. The shown shape of the contact branches 5a facilitates reliable clamping and good contacting.

### REFERENCE NUMBERS

1 Housing
2 Connector
3a, 3b Grooves
4 Printed circuit board
5 Contact pins
5a Contact branches
6 Contact forks
6a Section
6b Free end
6c Bent section
7 Conductor
8 Slotted-type pocket

1. An ignition coil for an internal combustion engine, comprising a housing which holds a connector and is potted with an electrically insulating compound, wherein
the connector holds a printed circuit board,
the connector comprises contact pins for contacting a female connector matching the connector, said contact pins being pressed into the printed circuit board,
contact forks which each clamp a conductor in the interior region of the housing are inserted into the printed circuit board.

2. The ignition coil according to claim 1, wherein the connector is connected to a housing wall by means of a tongue and groove connection.

3. The ignition coil according to claim 2, wherein the connector is connected to a housing wall by means of a tongue and groove connection on opposite sides.

4. The ignition coil according to claim 2, wherein the housing wall comprises the groove of the tongue and groove connection.

5. The ignition coil according to claim 1, wherein the contact forks project into a slotted-type pocket.

6. The ignition coil according to claim 1, wherein the contact forks comprise a bent section between a section inserted into the printed circuit board and a free end.

7. The ignition coil according to claim 1, wherein the contact pins are each inserted into the printed circuit board with an end section which comprises a pair of contact branches with a clearance therebetween.

8. The ignition coil according to claim 7, wherein the contact branches of a pair of contact branches are connected to each other at their two ends.

9. The ignition coil according to claim 7, wherein the contact branches of a pair of contact branches are curved outwards.

10. The ignition coil according to claim 7, wherein the clearance between the branches of a pair of contact branches has the shape of a biconvex lens.
